(19) United States
(12) Patent Application Publication
(10) Pub. No.: US 2016/0236167 A1
(43) Pub. Date: Aug. 18, 2016

(54) Mercury Sorbent Material

(71) Applicant: NOVINDA CORPORATION, Denver, CO (US)

(72) Inventor: Michael A. Lucarelli, McMurray, PA (US)

(73) Assignee: Novinda Corporation, Denver, CO (US)

(21) Appl. No.: 15/029,175

(22) PCT Filed: Oct. 7, 2014
(86) PCT No.: PCT/US14/59383

§ 371 Date: Apr. 13, 2016

Related U.S. Application Data
(60) Provisional application No. 61/890,381, filed on Oct. 14, 2013.

(51) Int. Cl. B01J 20/02

(52) U.S. Cl. CPC B01J 20/0285; B01J 20/0288

(57) ABSTRACT

Herein is provided mercury sorbent compositions and methods for their manufacture. In embodiments, the mercury sorbent compositions can include calcium metal sulfides (CaₓM_{y}S_{z}), where M can be Cr, Mn, Fe, Co, Ni, Cu, Zn, or a mixture thereof where x can have a value from about 0.1 to about 5; where y can have a value of about 1, and where z can have a value of about 1 to about 10. In one example, the mercury sorbent composition can have the formula: Caₓ(Fe_{1-y}Cuy)S_{z}. In other embodiments, the mercury sorbent compositions can include copper sulfide carbonates (e.g., CuₓS_{y}(C03)_{z}; wherein x can have a value from about 1 to about 5, y can have a value from about 1 to about 10, and z can have a value from about 0.1 to about 2.5. In one example, the mercury sorbent compositions can have the formula CuSₓ(CO₃)_{y}.

### CROSS-REFERENCE TO RELATED APPLICATIONS

This disclosure claims the benefit of priority to U.S. Provisional Patent Application No. 61/890,381 filed Oct. 14, 2014, which is incorporated herein in its entirety.

### FIELD OF THE INVENTION

This disclosure relates to inorganic compounds applicable for the removal of mercury from flue gases produced by the combustion of coal.

### BACKGROUND

Emissions of from coal-fired and oil-fired power plants are a major environmental concern. In addition to acid gases, the emissions can include unacceptably high levels of toxic elements, including mercury, antimony, arsenic, cadmium, and lead. In the US, emissions from coal fired power plants are tightly regulated, in part because as mercury emissions from these plants are the largest anthropogenic source of mercury in the US. Due to regulatory changes in the United States, emissions from these coal-fired power plants have decreased from about 53 tonnes in 2005 to 27 tonnes in 2010; yet meeting increasingly tighter regulatory requirements requires new, selective mercury sorbents.

The classic method for sequestering mercury from flue gas is the injection of powdered activated carbon (PAC) or modified-PAC into the flue stream. The carbon material provides a high surface area for chemisorption of mercury gases and agglomeration of particle bound mercury. One disadvantage of adding PAC into the flue gas is the retention of the material in the fly-ash-waste stream. Fly ash from coal-fired power plants if often added to concrete, where the presence of the activated carbon adversely affects the performance. Other disadvantages of PAC are a low shelf-life (as a non-selective chemisorbant PAC adsorbs deactivating materials from the air and often needs to be reactivated prior to use) and high CO2 emissions during production.

Inorganic based methods for sequestering mercury often rely on the formation of a mercuric sulfide, an isolatable form of mercury with significantly lower environmental toxicity than other mercuric salts. The mercuric sulfides can be formed, for example, from elemental sulfur, inorganic and organic polysulfides, inorganic sulfides, or organic thioketones (e.g., thioamides, lawesson's reagent) and the reduced or oxidized form of mercury.

U.S. Pat. Nos. 6,719,828; 7,048,781, RE44,124; U.S. Pat. Nos. 7,704,920; 8,480,791; and 8,8685,351 teach mercury-reactive, metal sulfides carried on inorganic supports. Despite these materials, there is still an ongoing need for advanced mercury sorbent materials applicable both in the flue gas environment and post-sorption in fly-ash-waste streams. A number of improvements are desirable including sorption of both reduced and oxidized mercury, stability of the collected mercury form for prolonged environmental sequestration, enhanced sorption reaction rates, greater potential-mercury loading, and supply chain compatibility. Accordingly, there is an ongoing need to improve pollution control sorbents, methods of their manufacture, and methods of their use.

### SUMMARY

In a first embodiment herein is provided a composition that includes an inorganic support carrying a compound having a formula CaₓM_{y}S_{z}; where M is selected from the group consisting of Cr, Mn, Fe, Co, Ni, Cu, Zn, and a mixture thereof, where x has a value from about 0.1 to about 5, about 0.5 to about 2, or about 0.5 to about 1.5; where y has a value of about 1, and where z has a value of about 1 to about 10, about 1 to about 5, or about 1 to about 4; and a method of its manufacture.

In a second embodiment, an inorganic compound having a formula: Caₓ(Fe₁₋ᵤCu_{y})S_{z}; wherein x has a value from about 0.1 to about 2; and wherein z has a value from about 1.1 to about 3.1; is provided with a method of its manufacture.

In a third embodiment, a composition that includes an inorganic support selected from the group consisting of a silicate, an aluminate, an aluminosilicate, a transition metal oxide, an elemental carbon, and a mixture thereof; the inorganic support carrying a copper sulfide carbonate; is provided with a method of its manufacture.

In a fourth embodiment, an inorganic compound having a formula CuSₓ(CO₃)_{y}; wherein x has a value from about 0.1 to about 0.9; wherein y has a value from about 0.1 to about 0.9; and wherein x+y≈1; is provided with a method of its manufacture.

### DETAILED DESCRIPTION

Herein are disclosed new, mercury-sorbent compositions and processes of manufacturing these compositions. Within disclosed embodiments are homogeneous and inhomogeneous compositions that can vary based on the relative ratios of elements. Accordingly, these compositions are presented with subscript variables (e.g., l, m, n, x, y, z) as is common in the art. As multiple embodiments are presented and a limited number of variables are commonly employed in the art, the same variables appear in different compositions, in different embodiments. Notably, definitions of values or ranges of values for these variables are provided for each embodiment and care was taken to distinguish as much as possible between them. Moreover, unless specifically noted, the herein disclosed compositions can include additional elements not enumerated in the generalized compositional formulation. For example, a composition AₓB_{y}C_{z} may further include waters of hydration, alkali metals (e.g., to balance charge), and/or halides (e.g., to balance charge).

A first embodiment is the composition, process of manufacturing, and use of calcium metal sulfides. In one instance, the composition can include an inorganic support and a calcium metal sulfide that has the formula CaₓM_{y}S_{z}. In this instance, the inorganic support carries the calcium metal sulfide. That is, the inorganic support and calcium metal sulfide are bound, adhered, or otherwise attached; for example, the inorganic support and calcium metal sulfide are not a heterogeneous mixture. The calcium metal sulfide can be intercalated into the inorganic support but are more preferable attached to an exposed (exterior) surface of the inorganic support. Preferably, the inorganic support is thermally stable to a temperature of at least 400° C., 500° C., 600° C., 700° C., 800° C., 900° C., or 1,000° C., more preferably the inorganic support is thermally stable in the presence of oxygen.

The inorganic support is preferably a material selected from the group consisting of silicates, aluminates, aluminosilicates, transition metal oxides, elemental carbons, and mixtures thereof. Specific examples of inorganic supports include titanates, vanadates, tungstates, molybdates, and ferrates; phyllosilicates (e.g., bentonite, montmorillonite, hectorite, beidellite, saponite, nontronite, volkonskoite, sauconite, stevensite, and/or a synthetic smectite derivative, particularly fluorohectorite and laponite); mixed layered clay (e.g., rectonite and their synthetic derivatives); vermiculite, illite, micaceous minerals, and their synthetic derivatives; layered hydrated crystalline polysilicates (e.g., makatite, kanemite, octasilicate (illierite), magadiite and/or kenyaite); attapulgite, palygorskite, sepoilite; allophane, graphite, alumina, quartz, and mixtures thereof. Preferably, the inorganic support is a silicate, aluminate, aluminosilicate, or mixture thereof. Some examples of preferable inorganic supports include bentonite, montmorillonite, fly ash (an aluminosilicate produced by the combustion of fossil fuels, e.g., coal), zeolites, used solid state catalysts, and powdered carbon. Even more preferably, the inorganic support is a bentonite, montmorillonite, or fly ash.

The inorganic support carries a calcium metal sulfide (CaₓM_{y}S_{z}) where the metal (a metal cation; M) is, preferably a first row transition metal. Preferable examples of the metal include Cr, Mn, Fe, Co, Ni, Cu, Zn, and mixtures thereof. More preferably, the metal is a divalent cation; even more preferable, the metal is selected from the group consisting of Fe, Cu, and a mixture thereof. Still more preferably, the metal is copper. Alternatively, the metal can be tin, antimony, or a combination of tin and/or antimony with a first row transition metal.

When the calcium metal sulfide is represented by the formula CaₓM_{y}S_{z} the variable x can have a value from about 0.1 to about 5, the variable y has a value of about 1, and z can have a value of about 1 to about 10. Notably, the structure and composition of the calcium metal sulfide is not limited by the numerical values of the variables, that is, the formula does not limit the composition in a crystallographic unit cell or in a discrete particle. In a preferable embodiment, the variable x has a value from about 0.5 to about 2, the variable y has a value of about 1, and the variable z has a value of about 1 to about 5. In a more preferable embodiment, the variable x has a value from about 0.5 to about 1.5, the variable y has a value of about 1, and the variable z has a value of about 1 to about 4.

The calcium metal sulfide, as disclosed above, can further include other elements and/or functional groups (e.g., hydroxide). In one preferable instance, the calcium metal sulfide includes bromine (Br). The inclusion of bromine can be represented in the formula as Br, (CaₓM_{y}S_{z}Brₙ). When the inclusion of bromine is represented as Brₙ, the variable n can have a value from about 0.02 to about 5, more preferably, a value from about 0.1 to about 2.

The sulfur moiety of the calcium metal sulfide can be a terminal sulfide (═S), a bridging sulfide (—S—), a polysulfide [—S—(S)ₓ—S—], a thiolate (—SH), or can be combinations thereof. The sulfides and polysulfides can be represented by the formula (S_{α})_{β}(S)_{χ}; wherein S_{α} represents the polysulfides with the variable α denoting the total number of sulfur atoms involved in polysulfide chains/groups; the variable β denoting the number of polysulfide groups, and the variable χ denoting the number of sulfides (bridging and/or terminal). Notably and due to the nature of sulfur in inorganic complexes, the polysulfide [—S—(S)ₓ—S-] can be a persulfide (—S—S—) or polysulfide, that is the variable x, as used in the formula [—S—(S)ₓ—S—], can have a value of 0, 1, 2, or 3; preferable the variable x has a value of 0, 1, or 2. That is the persulfide is preferable a persulfide (—S—S—), the trisulfide (—S—S—S—), the tetrasulfide (—S—S—S—S—) or mixture thereof. In a preferable instance, the calcium metal sulfide includes both sulfides and polysulfides and the total number of sulfur atoms in the sulfides corresponds to the number represented in the formula CaₓM_{y}S_{z} by the relationship S_{z}═[(S_{α})_{β}(S)_{χ}].

Still further, the composition can include other materials, compounds, or formulations carried by the inorganic support or as a solid admixture of the inorganic support carrying the calcium metal sulfide. In one instance, the inorganic support further carries a sodium sulfate and/or a sodium bromide.

In another example, the composition is a calcium copper sulfide carried by an inorganic support. That is, the inorganic support and calcium copper sulfide are bound, adhered, or otherwise attached. The calcium copper sulfide can be intercalated into the inorganic support but is more preferable attached to an exposed (exterior) surface of the inorganic support. Preferably, the inorganic support is thermally stable to a temperature of at least 400° C., 500° C., 600° C., 700° C., 800° C., 900° C., or 1,000° C., more preferably the inorganic support is thermally stable in the presence of oxygen.

The inorganic support is preferably a material selected from the group consisting of silicates, aluminates, aluminosilicates, transition metal oxides, elemental carbons, and mixtures thereof. Specific examples of inorganic supports include titanates, vanadates, tungstates, molybdates, and ferrates, phyllosilicates (e.g., bentonite, montmorillonite, hectorite, beidellite, saponite, nontronite, volkonskoite, sauconite, stevensite, and/or a synthetic smectite derivative, particularly fluorohectorite and laponite); mixed layered clay (e.g., rectonite and their synthetic derivatives); vermiculite, illite, micaceous minerals, and their synthetic derivatives; layered hydrated crystalline polysilicates (e.g., makatite, kanemite, octasilicate (illierite), magadiite and/or kenyaite); attapulgite, palygorskite, sepoilite; allophane, graphite, alumina, quartz, and mixtures thereof. Preferably, the inorganic support is a silicate, aluminate, aluminosilicate, or mixture thereof. Some examples of preferable inorganic supports include bentonite, montmorillonite, fly ash (an aluminosilicate produced by the combustion of fossil fuels, e.g., coal), zeolites, used solid state catalysts, and powdered carbon. Even more preferably, the inorganic support is a bentonite, montmorillonite, or fly ash.

In one instance, the calcium copper sulfide can be represented by the formula CaₗCuₘ[(S_{α})_{β}(S)_{χ}]. The sulfides and polysulfides are represented by the formula (S_{α})_{β}(S)_{χ}; wherein S_{α} represents the polysulfides with the variable α denoting the total number of sulfur atoms involved in polysulfide chains/groups; the variable β denoting the number of polysulfide groups, and the variable χ denoting the number of sulfides (bridging and/or terminal). Preferably, the calcium copper sulfide is not ionic, that is the calcium and copper cations balance the charge of the sulfur groups. This non-ionic nature can be represented by the equation l+m=β+χ. The variables l and m can, individually, have a value in a range of about 0.2 to about 2; preferably, the value of m is about 1 and the value of l is in the range of about 0.2 to about 2, about 0.5 to about 1.5, or about 0.75 to about 1.25.

In another instance, the calcium copper sulfide is a calcium copper bromosulfide. For example, the calcium copper bromosulfide can have a formula of CaₗCuₘBrₙ[(S_{α})_{β}(S)_{χ}] where (S_{α})_{β}(S)_{χ} represents the sulfides and polysulfides. Preferably, the variables conform to an equation where 2(l+m)=n+2((β+χ). In this instance, the variables l and m can, individually, have a value in a range of about 0.2 to about 2; preferably, the value of m is about 1 and the value of l is in the range of about 0.2 to about 2, about 0.5 to about 1.5, or about 0.75 to about 1.25. The variable n can have a value in a range of about 0.1 to about 4, about 0.5 to about 3, or about 1 to about 2.

In this embodiment, the composition can further include a calcium sulfide and/or a copper sulfide. In one instance, the composition includes a calcium sulfide carried by the inorganic support. In another instance, the composition includes a copper sulfide carried by the inorganic support. The inclusion of the calcium sulfide and/or copper sulfide is not represented in or included in the calcium copper sulfide formula CaₗCuₘ[(S_{α})_{β}(S)_{χ}] as the calcium and copper sulfides are discrete materials identifiable by, for example, powder X-ray diffraction.

Yet another example is an inorganic compound having the formula Caₓ(Fe_{1-y}Cu_{y})S_{z}. Preferably, the variable x has a value in a range from about 0.1 to about 2, or from about 0.7 to about 1.3. Preferably, the variable z has a value from about 1.1 to about 3.1, or from about 1.3 to about 2.3. More preferably, the values of the variables x and z satisfy the equation x+1=z. In one instance, the variable y has a value in the range of zero (0) to one (1). In one preferable instance, y has a value of 1; in another preferable instance, y has a value of 0. In still another preferable instance, y has a value equal to or greater than 0.5 (y≧0.5), 0.6, 0.7 0.8, or 0.9. In still another instance, the sulfur moiety S_{z} can include sulfides, polysulfides, thiolates, and combinations thereof. Preferably, S_{Z} is represented by the formula [(S_{α})_{β}(S)_{χ}] where (α*β)+χ=z. When sulfides and polysulfides are represented by the formula (S_{α})_{β}(S)_{χ}: S_{α} represents the polysulfides with the variable α denoting the total number of sulfur atoms involved in polysulfide chains/groups; the variable β denoting the number of polysulfide chains or groups, and the variable z denoting the number of sulfides (bridging and/or terminal).

In still another example, a compound is manufactured by a process that includes admixing a calcium salt and a transition metal-salt (TM-salt) that has a transition metal cation (TM-cation) and an anion. The TM-cation is a cation of a transition metal, preferably a first row transition metals, for example a transition metal selected from a group consisting of Cr, Mn, Fe, Co, Ni, Cu, Zn, and a mixture thereof. Preferably, the transition metal is selected from the group consisting of Fe, Cu, and a mixture thereof. The anion (anionic component of the transition metal salt) can be any anion that is dissociable from the transition metal cation; examples include but are not limited to anions selected from the group consisting of chloride, bromide, iodide, sulfate, hydroxide, acetate, nitrate, and a mixture thereof. Preferably, the anion is selected from bromide, sulfate, hydroxide, and a mixture thereof. Even more preferably, the anion is a bromide, a sulfate, or a mixture thereof.

Preferably, the process includes admixing the calcium salt and the TM-salt in the presence of an inorganic support. The inorganic support is preferably a material selected from the group consisting of silicates, aluminates, aluminosilicates, transition metal oxides, elemental carbons, and mixtures thereof. Specific examples of inorganic supports include titanates, vanadates, tungstates, molybdates, and ferrates, phyllosilicates (e.g., bentonite, montmorillonite, hectorite, beidellite, saponite, nontronite, volkonskoite, sauconite, stevensite, and/or a synthetic smectite derivative, particularly fluorohectorite and laponite); mixed layered clay (e.g., rectonite and their synthetic derivatives); vermiculite, illite, micaceous minerals, and their synthetic derivatives; layered hydrated crystalline polysilicates (e.g., makatite, kanemite, octasilicate (illierite), magadiite and/or kenyaite); attapulgite, palygorskite, sepoilite; allophane, graphite, alumina, quartz, and mixtures thereof. Preferably, the inorganic support is a silicate, aluminate, aluminosilicate, or mixture thereof. Some examples of preferable inorganic supports include bentonite, montmorillonite, fly ash (an aluminosilicate produced by the combustion of fossil fuels, e.g., coal), zeolites, used solid state catalysts, and powdered carbon. Even more preferably, the inorganic support is a bentonite, montmorillonite, or fly ash.

Still further, the process, preferably, includes admixing the admixture of the calcium salt and the TM-salt (including or excluding the inorganic support) with a sulfide or a thiocarbonate. Here, the sulfide can be selected from the group consisting of hydrogen sulfide, an alkali metal sulfide, an alkali earth sulfide, an ammonium sulfide, a carbon sulfide, a bis(alkyl/aryl/carboxyl)trisulfide, and a mixture thereof. The thiocarbonate can selected from the group consisting of (Na/K)₂(CO₂S), (Na/K)₂(COS₂), (Na/K)₂(CS₃), and a mixture thereof.

In one preferable instance, the admixture of the calcium salt and the TM-salt are admixed in the presence of the inorganic support. This admixture is then admixed with an alkali metal sulfide, for example sodium or potassium sulfide (Na₂S or K₂S). Preferably, the sulfide is not anhydrous; examples of hydrated sodium sulfide include sodium sulfide trihydrate and sodium sulfide nonahydrate. Still more preferably, a calcium bromide is admixed with a copper sulfate in the presence of the inorganic support and this admixture is then admixed with a sodium sulfide. This process can further include washing or extracting salts (e.g., sodium sulfate) from the calcium metal sulfide, for example by rinsing the calcium metal sulfide with water.

The admixing of the materials described above preferably includes mechanical shearing of the materials. Mechanical shearing methods may employ extruders, injection molding machines, Banbury® type mixers, Brabender® type mixers, pin-mixers, and the like. Shearing also can be achieved by introducing materials at one end of an extruder (single or double screw) and receiving the sheared material at the other end of the extruder. Optionally, materials can be added at intermediate locations in the extruder or, for example, materials such as the calcium salt, TM-salt, and inorganic support can be extruded and then admixed and extruded with the sulfide. The temperature of the materials entering the extruder, the temperature of the extruder, the concentration of materials added to the extruder, the amount of water added to the extruder, the length of the extruder, residence time of the materials in the extruder, and the design of the extruder (single screw, twin screw, number of flights per unit length, channel depth, flight clearance, mixing zone, etc.) are several variables which control the amount of shear applied to the materials.

Still another example is a process that includes admixing a calcium salt, a copper salt, and an inorganic support to form a supported calcium copper intermediate. The supported calcium copper intermediate is then admixed with a sulfide, for example an alkali metal, alkali earth, or ammonium sulfide. Here and as described above, the admixing of the materials, preferably, includes mechanical shearing of the materials.

In one instance, the calcium salt and/or the copper salt are hydrated. In another instance, the calcium salt, copper salt and inorganic support are admixed in the presence of a sufficient quantity of water to facilitate a salt metathesis reaction. In still another instance, the sulfide is hydrated. Notably, the amount of water necessary is dependent on the shearing process, time, and rate of salt metathesis reactions. Preferably, the hydrated salts or the added water is sufficient to facilitate the salt metathesis reaction but not turn the mixture into a loose slurry or heterogeneous solution. For example, the admixed materials, preferably, includes less than 25 wt. % water, more preferably less than 20 wt. %, 15 wt. %, 10 wt. % or 5 wt. % water.

Another example is a process that includes admixing a calcium hydroxide, a copper salt, and an inorganic support to form a supported calcium copper intermediate and then admixing the supported calcium copper intermediate with a poly-sulfur compound. The process of admixing the supported calcium copper intermediate with the poly-sulfur compound can include admixing the supported calcium copper intermediate with elemental sulfur and/or a sulfide (e.g., X₂(S) or X(S)) selected from the group consisting of a hydrogen sulfide, an alkali metal sulfide, an alkali earth sulfide, an ammonium sulfide, or a polysulfide.

In this first embodiment, the calcium salt can be selected from calcium hydroxides, calcium oxides, calcium fluorides, calcium chlorides, calcium bromides, calcium iodides, calcium carbonates, calcium sulfates, calcium perchlorates, calcium phosphates, calcium nitrates, calcium hypochlorites, calcium permanganates, calcium carboxylates, and mixtures thereof. Preferably, the calcium salt is selected from calcium hydroxides, calcium oxides, calcium sulfates, and calcium halides. More preferably, the calcium salt is calcium chloride and/or calcium bromide. In one particularly preferable instance, the calcium salt is a calcium bromide. Preferable, the transition metal-salt is selected from the group consisting of iron chloride, iron bromide, iron sulfate, iron carbonate, iron oxide, copper chloride, copper bromide, copper sulfate, copper carbonate, copper oxide, copper hydroxide, and a mixture thereof. More preferably, the transition metal-salt is selected from the group consisting of iron chloride, iron bromide, iron sulfate, copper chloride, copper bromide, copper sulfate, and a mixture thereof. In one particularly preferable instance, the transition metal salt is selected from the group consisting of iron sulfate, copper sulfate, and a mixture thereof.

A second embodiment is the composition, process of manufacturing, and use of copper sulfide carbonates. In one example, the composition can include an inorganic support and a copper sulfide carbonate which can have the formula CuₓS_{y}(CO₃)_{z}. In this instance, the inorganic support carries the copper sulfide carbonate. That is, the inorganic support and copper sulfide carbonate are bound, adhered, or otherwise attached; for example, the inorganic support and copper sulfide carbonate are not a heterogeneous mixture. The copper sulfide carbonate can be intercalated into the inorganic support but are more preferable attached to an exposed (exterior) surface of the inorganic support. Preferably, the inorganic support is thermally stable to a temperature of at least 400° C., 500° C., 600° C., 700° C., 800° C., 900° C., or 1,000° C., more preferably the inorganic support is thermally stable in the presence of oxygen. In a preferable instance, the composition is substantially free of, or essentially free of halides, more preferably, the composition is free of halides (e.g., sodium chloride, sodium bromide, calcium bromide, and other halide salts).

The inorganic support is preferably a material selected from the group consisting of silicates, aluminates, aluminosilicates, transition metal oxides, elemental carbons, and mixtures thereof. Specific examples of inorganic supports include titanates, vanadates, tungstates, molybdates, and ferrates, phyllosilicates (e.g., bentonite, montmorillonite, hectorite, beidellite, saponite, nontronite, volkonskoite, sauconite, stevensite, and/or a synthetic smectite derivative, particularly fluorohectorite and laponite); mixed layered clay (e.g., rectonite and their synthetic derivatives); vermiculite, illite, micaceous minerals, and their synthetic derivatives; layered hydrated crystalline polysilicates (e.g., makatite, kanemite, octasilicate (illierite), magadiite and/or kenyaite); attapulgite, palygorskite, sepoilite; allophane, graphite, alumina, quartz, and mixtures thereof. Preferably, the inorganic support is a silicate, aluminate, aluminosilicate, or mixture thereof. Some examples of preferable inorganic supports include bentonite, montmorillonite, fly ash (an aluminosilicate produced by the combustion of fossil fuels, e.g., coal), zeolites, used solid state catalysts, and powdered carbon. Even more preferably, the inorganic support is a bentonite, montmorillonite, or fly ash.

When the copper sulfide carbonate is represented by the formula CuₓS_{y}(CO₃)_{z} the variable x can have a value from about 1 to about 5 or from about 1 to about 2.5; the variable y can have a value from about 1 to about 10 or from about 1 to about 5; and the variable z can have a value from about 0.1 to about 2.5 or from about 0.5 to about 1.5.

The sulfur moiety of the copper sulfide carbonate can be a terminal sulfide (═S), a bridging sulfide (—S—), a polysulfide [—S—(S)ₓ—S—], a thiolate (—SH), or can be combinations thereof. The sulfides and polysulfides can be represented by the formula (S_{α})_{β}(S)_{χ}; wherein S_{α} represents the polysulfides with the variable α denoting the total number of sulfur atoms involved in polysulfide chains/groups; the variable β denoting the number of polysulfide groups, and the variable χ denoting the number of sulfides (bridging and/or terminal). Notably and due to the nature of sulfur in inorganic complexes, the polysulfide [—S—(S)ₓ—S-] can be a persulfide (—S—S—) or polysulfide, that is the variable x, as used in the formula [—S—(S)ₓ—S—], can have a value of 0, 1, 2, or 3; preferable the variable x has a value of 0, 1, or 2. That is the persulfide is preferable a persulfide (—S—S—), the trisulfide (—S—S—S—), the tetrasulfide (—S—S—S—S—) or mixture thereof. In a preferable instance, the copper sulfide carbonate includes both sulfides and polysulfides and the total number of sulfur atoms in the sulfides corresponds to the number represented in the formula CuₓS_{y}(CO₃)_{z} by the relationship S_{y}═[(S_{α})_{β}(S)_{χ}](y=αβ+χ).

Still further, the composition can include other materials, compounds, or formulations carried by the inorganic support or as a solid admixture of the inorganic support carrying the copper sulfide carbonate. In one instance, the inorganic support further carries a sodium sulfate and/or a carbonate salt. The carbonate salt can be selected from the group consisting of an ammonium carbonate, a lithium carbonate, a sodium carbonate, a potassium carbonate, a magnesium carbonate, a calcium carbonate, and a mixture thereof.

In another example, the composition is an inorganic compound having the formula CuSₓ(CO₃)_{y}. In one instance, the variable x can have a value from about 0.01 to about 0.99, about 0.05 to about 0.95, about 0.1 to about 0.9, about 0.2 to about 0.8, about 0.3 to about 0.7, about 0.5 to about 0.95, about 0.75 to about 0.95, or about 0.75 to about 0.9. The variable y can have a value from about 0.01 to about 0.99, about 0.05 to about 0.95, about 0.1 to about 0.9, about 0.2 to about 0.8, about 0.3 to about 0.7, about 0.05 to about 0.5, about 0.05 to about 0.25, or about 0.1 to about 0.25. Preferable, the combined sulfide and carbonate anionic change balance the copper's cationic change such that x+y≈1, when the formula is based on Cu₁.

In this example, the sulfur moiety of the inorganic compound having the formula CuSₓ(CO₃)_{y} can be a terminal sulfide (═S), a bridging sulfide (—S—), a polysulfide [—S—(S)ₓ—S—], a thiolate (—SH), or can be combinations thereof. In one instance the sulfur moiety can be represented by the formula Sₓ═[(S_{α})_{β}(S)_{χ}] wherein S_{α} represents the polysulfides with the variable α denoting the total number of sulfur atoms involved in polysulfide chains/groups; the variable β denoting the number of polysulfide groups, and the variable x denoting the number of sulfides (bridging and/or terminal). Notably and due to the nature of sulfur in inorganic complexes, the polysulfide [—S—(S)ₓ—S-] can be a persulfide (—S—S—) or polysulfide, that is the variable x, as used in the formula [—S—(S)ₓ—S—], can have a value of 0, 1, 2, or 3; preferable the variable x a value of 0, 1, or 2. That is, the persulfide is preferable a persulfide (—S—S—), the trisulfide (—S—S—S—), the tetrasulfide (—S—S—S—S—) or mixture thereof. In a preferable instance, the variables conform to equations wherein (α*β+χ)+y=1, and wherein α*β+χ=x. That is, the inorganic compound having the formula CuSₓ(CO₃)_{y} includes both sulfides and polysulfides and the total number of sulfur atoms is determined by the formula CuSₓ(CO₃)_{y}, the equation Sₓ═[(S_{α})_{β}(S)_{χ}], and the values for variable x provided above.

Still another example is a process of manufacturing copper sulfide carbonate. In one instance the process includes providing a basic copper carbonate (e.g., Cu₂(OH)₂(CO₃)) carried by an inorganic support; and then admixing the basic copper carbonate with a sulfide salt. The basic copper carbonate can be provided by the process of admixing a copper salt, for example a copper sulfate and/or copper halide, a carbonate salt, and the inorganic support. This process can further include washing or extracting salts (e.g., sodium sulfate) from the copper sulfide carbonate carried by the inorganic support, for example by rinsing the copper sulfide carbonate with water.

The copper salt is, preferably, selected from the group consisting copper chloride, copper bromide, copper sulfate, copper oxide, copper hydroxide and a mixture thereof. More preferably, the copper salt is selected from the group consisting of copper chloride, copper bromide, copper sulfate, and a mixture thereof. In one particularly preferable instance, the copper salt is copper sulfate.

The carbonate salt can be selected from the group consisting of an ammonium carbonate, a lithium carbonate, a sodium carbonate, a potassium carbonate, a magnesium carbonate, a calcium carbonate, and a mixture thereof. In one preferable instance, the carbonate salt is a sodium carbonate (Na₂CO₃), a sodium bicarbonate (NaHCO₃), or a mixture thereof (e.g., sodium sesquicarbonate). In a more preferable instance the sodium carbonate is Trona (i.e., Na₃(CO₃)(HCO₃).2H₂O).

In this example the inorganic support can be selected from those inorganic supports disclosed above; preferable, the inorganic support is selected from the group consisting of a silicate, an aluminate, an aluminosilicate, a transition metal oxide, an elemental carbon, and a mixture thereof. Even more preferable, the inorganic support is selected from the group consisting of a silicate, an aluminate, an aluminosilicate, and a mixture thereof.

In one preferable instance, the copper salt (e.g., copper sulfate), carbonate salt, and inorganic support are admixed with water. The amount of water in the admixture is preferably enough, that is a sufficient quantity, to facilitate a salt metathesis reaction, for example, a salt metathesis reaction between the copper salt and the carbonate salt. In one instance the amount of water in the admixture can be about 5 wt. % to about 25 wt. %. In instances where the amount of water available from the waters of hydration of the salts in the admixture are insufficient to facilitate the salt metathesis reaction water can be added to the admixture, for example, to raise the amount of water to a range of about 5 wt. % to about 25 wt. %.

The admixing of the materials described above, preferably, includes mechanical shearing of the materials. Mechanical shearing methods may employ extruders, injection molding machines, Banbury® type mixers, Brabender® type mixers, pin-mixers, and the like. Shearing also can be achieved by introducing materials at one end of an extruder (single or double screw) and receiving the sheared material at the other end of the extruder. Optionally, materials can be added at intermediate locations in the extruder or, for example, materials such as the copper salt, the carbonate salt, and inorganic support can be extruded and then admixed and extruded with the sulfide. The temperature of the materials entering the extruder, the temperature of the extruder, the concentration of materials added to the extruder, the amount of water added to the extruder, the length of the extruder, residence time of the materials in the extruder, and the design of the extruder (single screw, twin screw, number of flights per unit length, channel depth, flight clearance, mixing zone, etc.) are several variables which control the amount of shear applied to the materials.

Still another embodiment is a process of capturing mercury employing any one of the herein disclosed compositions. In one instance, the process of capturing mercury employs a calcium metal sulfide and/or a copper sulfide carbonate. The process includes admixing the calcium metal sulfide and/or a copper sulfide carbonate with a fluid that contains mercury (e.g., Hg⁰, Hg¹⁺, and/or Hg²⁺). The fluid can be a liquid or a gas. Examples of liquids include wet scrubber solutions, solutions produced during the recovery of gold from ore, and ground water. Examples of gases include flue gases, such as those produced by the combustion of coal or produced during the manufacture of clinker. Preferable, the fluid is a flue gas from a coal fired boiler, that is, the gases produced by the combustion of coal. The process of capturing mercury can further include reacting the calcium metal sulfide and/or a copper sulfide carbonate with mercury in a flue gas and, preferable, separating the reaction product of the calcium metal sulfide and/or a copper sulfide carbonate and mercury from the flue gas.

In embodiments, examples, or instances where the calcium metal sulfide, copper sulfide carbonate, or a mixture thereof is carried by an inorganic support, the composition can include about 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 90 wt. %, or 95 wt. % of the inorganic support. Preferably, the composition includes about 40 wt. % to about 80 wt. % or about 50 wt. % to about 70 wt. % of the inorganic support. In one instance, the composition includes the calcium metal sulfide and about 50 wt. % wt. %, 60 wt. %, or 70 wt. % of the inorganic support. In another instance the composition includes the copper sulfide carbonate and about 50 wt. %, 60 wt. %, or 70 wt. % of the inorganic support. In some instances, the total weight percentage of the inorganic support can be determined by the amount by weight added in the manufacturing process. In such instances, the total weight percentage of the calcium metal sulfide, copper sulfide carbonate, or a mixture thereof can be the balance of the percentage (e.g., 60 wt. % inorganic support and 40 wt. % calcium metal sulfide). In other instances, the balance of the weight percentage includes both (a) the calcium metal sulfide, copper sulfide carbonate, or mixture thereof, and (b) the products of the reaction that formed the calcium metal sulfide, copper sulfide carbonate, or mixture thereof. For example, a process that can be employed to manufacture a copper sulfide carbonate can include the admixing of a copper sulfate, a sodium carbonate, and sodium sulfide in the presence of the inorganic support. This process will yield, in addition to the copper sulfide carbonate carried by the inorganic support, a sodium sulfate which is expected to be part of the composition unless specifically removed therefrom. Accordingly, the composition in this instance will include the inorganic support, the copper sulfide carbonate and, unless removed, the sodium sulfate. Notably, the ratio or amount of additional products can be determined by the balanced reactions when keeping the weight percentage of the inorganic support constant.

1. A composition comprising:
an inorganic support carrying a compound having a formula CaₓM_{y}S_{z}
where M is selected from the group consisting of Cr, Mn, Fe, Co, Ni, Cu, Zn, and a mixture thereof,
where x has a value from about 0.1 to about 2,
where y has a value of about 1, and
where z has a value of about 1 to about 5.

2. The composition of claim 1, wherein the inorganic support is selected from the group consisting of a silicate, an aluminate, an aluminosilicate, and a mixture thereof.

3. The composition of claim 1, wherein the compound further includes Brₙ; wherein n has a value from about 0.1 to about 2.

4. The composition of claim 1, where M is selected from the group consisting of Fe, Cu, and a mixture thereof.

5. The composition of claim 1, wherein S_{Z}═[(S_{α})_{β}(S)_{χ}].

6. The composition of claim 1, wherein the compound includes a thiolate.

7. The composition of claim 1, wherein the inorganic support carries a calcium copper sulfide.

8. The composition of claim 7, wherein the inorganic support is selected from the group consisting of a silicate, an aluminate, an aluminosilicate, and a mixture thereof.

9. The composition of claim 7, wherein the calcium copper sulfide has a formula of CaₓCu_{y}[(S_{α})_{β}(S)_{χ}] where x+y=β+χ.

10. The composition of claim 7, wherein the calcium copper sulfide is a calcium copper bromosulfide; preferably, wherein the calcium copper bromosulfide has a formula of CaₓCu_{y}Brₙ[(S_{α})_{β}(S)_{χ}] where 2(x+y)=n+2(β+χ).

11. The composition of claim 4, wherein the compound has the formula: Caₓ(Fe_{1-y}Cu_{y})S_{z};
wherein x has a value from about 0.1 to about 2;
wherein z has a value from about 1.1 to about 3.1.

12. The inorganic compound of claim 11, wherein y≧0.5.

13. (canceled)

14. A composition comprising:
an inorganic support selected from the group consisting of a silicate, an aluminate, an aluminosilicate, a transition metal oxide, an elemental carbon, and a mixture thereof;
the inorganic support carrying a copper sulfide carbonate having a formula
wherein x has a value from about 1 to about 5;
wherein y has a value from about 1 to about 10; and
wherein z has a value from about 0.1 to about 2.5.

15. The composition of claim 14,
wherein x has a value from about 1 to about 2.5;
wherein y has a value from about 1 to about 5; and
wherein z has a value from about 0.5 to about 1.5.

16. The composition of claim 14, wherein the inorganic support is selected from the group consisting of a silicate, an aluminate, an aluminosilicate, and a mixture thereof.

17. An inorganic compound comprising a formula CuSₓ(CO₃)_{y};
wherein x has a value from about 0.1 to about 0.9;
wherein y has a value from about 0.1 to about 0.9; and
wherein x+y≈1.

18. The inorganic compound of claim 17, wherein Sₓ═[(S_{α})_{β}(S)_{χ}].
